(19) United States
(12) Patent Application Publication
(10) Pub. No.: US 2023/0137881 A1
(43) Pub. Date: May 4, 2023

(54) STEALTH ELEMENT CONSTITUTED BY MULTIPLE THIN LAYERS ON MXENE SUBSTRATE FOR VISIBLE AND INFRARED CAMOUFLAGE

(71) Applicants: KOREA INSTITUTE OF SCIENCE AND TECHNOLOGY, Seoul (KR); KOREA UNIVERSITY RESEARCH AND BUSINESS FOUNDATION, Seoul (KR)

(72) Inventors: Chong Min KOO, Seoul (KR); Tae Yun KO, Seoul (KR); Jae Eun YOON, Seoul (KR); Soon Man HONG, Seoul (KR); Seon Joon KIM, Seoul (KR); Seung Sang HWANG, Seoul (KR); Albert Lee, Seoul (KR); Myung Ki KIM, Seoul (KR); Chang Hoon PARK, Seoul (KR); Ji Sung KWON, Seoul (KR)

(21) Appl. No.: 17/696,877

(22) Filed: Mar. 17, 2022

(30) Foreign Application Priority Data
Oct. 29, 2021 (KR) 10-2021-0146360

(51) Int. Cl. G02B 1/116; G02B 5/22

(52) U.S. Cl. CPC G02B 1/116; G02B 5/22; B82Y 30/00

(57) ABSTRACT

The present disclosure relates to a visible and infrared stealth element. The element of the present disclosure may selectively control thermal radiation energy according to a wavelength, and may also control a surface color and reflectance of near-infrared light and short-wavelength infrared light.

### CROSS-REFERENCE TO RELATED APPLICATION

This application claims priority to and the benefit of Korean Patent Application No. 10-2021-0146360, filed on Oct. 29, 2021, the disclosure of which is incorporated herein by reference in its entirety.

### BACKGROUND

### 1. Field of the Invention

The present disclosure relates to a visible and infrared stealth element. The element of the present disclosure may exhibit a camouflage function within a visible and infrared wavelength range. The element of the present disclosure may selectively control the thermal radiation energy of a heating object according to the wavelength, and may also control the reflection of visible and infrared wavelength light.

### 2. Discussion of Related Art

Stealth technology is a technology of concealing strategic military assets such as fighters or warships from radar detection equipment. Stealth technology can increase the survivability of strategic military assets. In addition to lasers, various infrared sensors have been developed due to development of an electro-optical technology according to entry into modern warfare. Currently, the infrared sensor is applied in surveillance of military facilities, or the like in the form of a heat-seeking missile and an infrared laser-guided missile.

The infrared sensor includes a thermal imaging camera or night vision goggles, a short-wavelength infrared camera, and the like. The former senses heat of a moving object. The latter senses a reflected signal of the moving object, specifically, a wavelength of reflected light of the moving object.

FIG. 1 illustrates the atmospheric transmittance of visible and infrared wavelength light and a detection range of an infrared sensor.

According to FIG. 1, in order to conceal the moving object from a thermal imaging camera, energy corresponding to mid-wave infrared (MWIR) light and long-wave infrared (LWIR) light among thermal radiation energy emitted from a surface of the moving object should be reduced because detection wavelengths of the thermal imaging camera are MWIR and LWIR. Meanwhile, when the thermal radiation energy is shielded in all wavelength ranges, since heat in the moving object cannot be emitted, the moving object can exhibit thermal instability. In this case, when the thermal energy is emitted at a wavelength other than a detection wavelength region of the thermal imaging camera, thermal stability of the moving object can be secured while reducing a detected signal.

The night vision goggles and a sensor in the short-wavelength infrared camera collect infrared signals reflected by the moving object. According to FIG. 1, in order to lower the signal detected by the night vision goggles and the short-wavelength infrared camera sensor, absorbance should be increased in a wavelength region in a range of 700 nm to 2,200 nm. The wavelength region corresponds to a near-infrared region and a short-wavelength infrared region.

In order to conceal the moving object from the naked eye, a color recognized by the naked eye should be controlled by controlling the reflectance of a visible ray reflected by the moving object.

Accordingly, for visible and infrared camouflage, as mentioned above, the light reflectance and emissivity should be selectively controlled according to the wavelength in a broadband from visible light to near-infrared and mid-infrared light. Conventionally, to this end, a metamaterial or a one-dimensional photonic crystal structure having a multi-layered thin film structure of 10 or more layers was used (for example, Patent Document 1). Here, the metamaterial is a material having the form of a nano-scale metal-insulator composite structure.

Several expensive semiconductor processes are required to manufacture the above-mentioned nanostructures. Accordingly, there is a limit to applying the above nanostructures to meter-scale military assets, such as fighters or tanks. In order to actually apply the stealth element to the military assets, an element having a simple and large area structure should be easily manufactured at low manufacturing costs.

### PRIOR-ART DOCUMENT

### Patent Document

(Patent Document 1) Laid-open Patent Application No. 10-2018-7037760

### SUMMARY OF THE INVENTION

Non-limiting objects of the present disclosure are as follows.

The present disclosure is directed to providing a stealth element capable of exhibiting a concealing function of a moving object in a wide range of wavelengths from visible light to infrared light.

The present disclosure is directed to providing a stealth element at low cost.

The present disclosure is directed to providing a stealth element with a large area.

The present disclosure is directed to providing a visible and infrared stealth element having all the above-described characteristics.

The means of the present disclosure for achieving the objects are as follows.

A visible and infrared stealth element of the present disclosure includes a MXene layer; a semiconductor layer present on the MXene layer; and a dielectric layer present on the semiconductor layer.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 illustrates the atmospheric transmittance of visible and infrared wavelength light and a detection range of an infrared sensor;

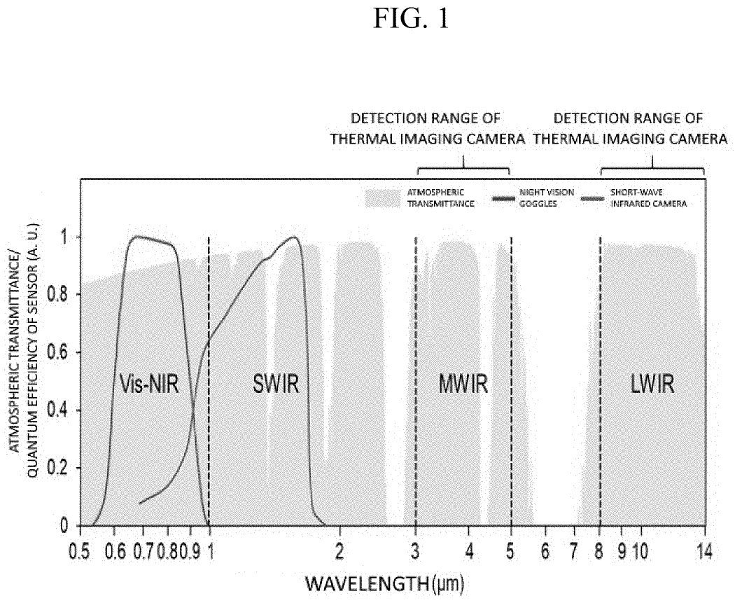

FIG. 2 is a schematic view of a visible and infrared stealth element of the present disclosure;

FIG. 3 illustrates the theoretical thermal emissivity according to a wavelength (3,000 nm to 14,000 nm) of the stealth element of the present disclosure;

FIG. 4 is a field scanning electron micrograph of a MXene material applied in the present disclosure;

FIG. 5 illustrates a surface temperature of the stealth element according to a thickness of the MXene;

FIG. 6 illustrates the theoretical light reflectance (top) and intensity of an reflected infrared signal (bottom) according to a wavelength (700 nm to 2,100 nm) of the stealth element of the present disclosure; and

FIG. 7 illustrates Commission Internationale de l'Eclairage (CLE) color coordinates of the stealth element of the present disclosure.

### DETAILED DESCRIPTION OF EXEMPLARY EMBODIMENTS

Hereinafter, the contents of the present disclosure will be described in more detail.

In the specification, unless specifically defined otherwise, specific physical properties are defined as terms known in the art.

The present disclosure relates to a stealth element.

In the present disclosure, the stealth element may refer to an element which functions so that a specific object (a moving object is a moving object) is not detected.

The stealth element of the present disclosure is an element which exhibits a stealth function even for light of a wide range from visible light to infrared light, and in the present disclosure, the element is referred to as a visible and infrared stealth element.

Further, the visible and infrared stealth element of the present disclosure is specifically suitable for exhibiting a stealth function of military equipment. As mentioned above, in order to be applied to military equipment, the visible and infrared stealth element should be low-cost, easily manufactured, and have a simple structure, and specifically, it should be possible to enlarge an area thereof. The visible and infrared stealth element of the present disclosure (hereinafter, may also be referred to as “element of the present disclosure”) may have all of these characteristics.

The element of the present disclosure may conceal the moving object from a thermal imaging camera. Further, the element of the present disclosure may conceal the moving object from night vision goggles and a short-wavelength infrared camera. The element of the present disclosure may conceal the moving object even in the visible light region.

As described above, when the element can shield the heat of the moving object in a wavelength range corresponding to mid-wave infrared (MWIR) light and long-wave infrared (LWIR) light, and dissipate the heat of the moving object in the remaining infrared region, it is possible to conceal the moving object from the thermal imaging camera. Accordingly, the element of the present disclosure may have low emissivity, for example, an average reflectance of 0.3 or less for a wavelength in a range of 8,000 nm to 14,000 nm and a wavelength in a range of 3,000 nm to 5,000 nm.

Further, as described above, when the element has a high light absorption rate in a near-infrared region and a short-wavelength infrared region, it is possible to conceal the moving object from the night vision goggles and the short-wavelength infrared camera. Accordingly, the element of the present disclosure may have an average absorption rate of 0.6 or more for a wavelength in a range of 700 nm to 2,200 nm.

Further, as described above, when the element can realize various colors, it is possible to perform camouflage in the visible light region. Accordingly, the element of the present disclosure appropriately controls the reflectance within a wavelength in a range of 380 nm to 700 nm. As a result, the element of the present disclosure may make a color of light reflected by the element similar to that of a natural object around the moving object concealed by the element.

In the present disclosure, the term “concealment or occlusion” may refer that a specific moving object may not be detected by a detection sensor using light based on a specific wavelength, or that intensity is insignificant even when the moving object can be detected.

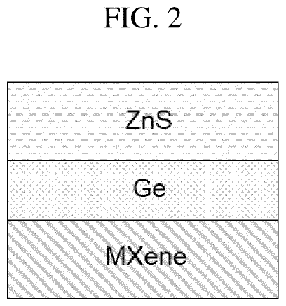

To this end, the element of the present disclosure has a structure in which a semiconductor layer and a dielectric layer are sequentially stacked on a MXene layer which is a base material. That is, the element of the present disclosure includes the MXene layer, the semiconductor layer present on the MXene layer, and the dielectric layer present on the semiconductor layer. Specifically, the element of the present disclosure has a characteristic of having a structure in which the semiconductor layer and the dielectric layer are stacked on the MXene layer. FIG. 2 is a schematic view of an example of a visible and infrared stealth element of the present disclosure. In FIG. 2, MXene refers to the MXene layer, Ge refers to the semiconductor layer, and ZnS refers to the dielectric layer.

The MXene refers to a specific material composed of 3 to 7 atomic layers and having a two-dimensional crystal structure. Specifically, the MXene refers to a transition metal carbide, transition metal nitride, transition metal carbonitride, or the like. The MXene has high electrical conductivity and excellent mechanical properties. Accordingly, the MXene is attracting attention as a next-generation two-dimensional nanomaterial suitable for an active material, an electrode, an additive, or the like in fields such as energy storage, flexible elements, electromagnetic wave shielding, and the like.

A MXene material is a compound (MX) of a transition metal (M: Ti, V, Cr, Ta, Nb, or the like) and carbon or nitrogen (X: C or N), and is named using the suffix “ene”, which means electrical conductivity. The MXene is usually manufactured by selectively etching an intermediate layer element (A: group 13 or group 14 elements such as Al, Si, Ga, or the like) in a MAX material which is, a three-component layered compound composed of transition metal (M), carbon or nitrogen (X), and the intermediate layer element (A).

The MXene is a material having a two-dimensional structure, and the material itself has a nano-scale multilayer thin film structure. Accordingly, the MXene may easily control optical and thermal characteristics even with a simple structure. Unlike conventional light and heat-related materials, the MXene may be applied in a spray form, and thus a large-area type structure may be easily manufactured at low cost. Since the element of the present disclosure corresponds to a stacked structure in which this MXene layer is a base material, the above-described advantages may be achieved through application of the MXene.

The element of the present disclosure specifically has a very thin shape. In the present disclosure, each layer constituting the element may be designed in nano-scale.

In one embodiment, a thickness of the MXene layer may be, for example, 200 nm or more. Specifically, the thickness of the MXene layer may be in a range of 200 nm to 1 mm. However, the present disclosure is not limited thereto, and the thickness may be appropriately controlled according to an application target of the element of the present disclosure, a target concealment range, and the like. In another embodiment, the thickness of the MXene layer may be 300 nm or more, 400 nm or more, 500 nm or more, 600 nm or more, 700 nm or more, 800 nm or more, 900 nm or more, or 1,000 nm or more, and may also be 500 μm or less, 300 μm or less, 200 μm or less, 100 μm or less, 50 μm or less, 30 μm or less, 20 μm or less, 10 μm or less, 5 μm or less, 3 μm or less, or 1 μm or less.

As described above, the MXene is a structure in which the intermediate layer element (A) is etched in a crystalline material generalized to MAX, and exhibits electrical conductivity (using the suffix “-ene”), and thus may be represented as MXene. In this case, Chemical Formulas of the MXene may be expressed by the following Chemical Formula 1 or Chemical Formula 2, and in the present disclosure, the MXene expressed in this way may be used without limitation.

Mₙ₊₁XₙTₓ [Chemical Formula 1]

In Chemical Formula 1, M is a group IIIB metal, a group IVB metal, a group VB metal, or a group VIB metal, X is C, N, or a combination thereof, Tₓ is a functional group including O, F, —OH or Cl, and n is an integer in the range of 1 to 4.

M′₂M″ₙXₙ₊₁Tₓ [Chemical Formula 2]

In Chemical Formula 2, M′ and M″ are each independently a group IIIB metal, a group IVB metal, a group VB metal, or a group VIB metal, M′ and M″ are different from each other, X is C, N, or a combination thereof, Tₓ is a functional group including O, F, —OH or Cl, and n is an integer of 1 or 2.

In Chemical Formula 1 or Chemical Formula 2, T may be 0, F, —OH, or Cl.

In one embodiment, in the present disclosure, Ti₃C₂Tₓ may be applied as a MXene. Ti₃C₂Tₓ includes all of Ti₃C₂OH₂, Ti₃C₂F₂, Ti₃C₂O₂ and the like. The MXene used in the present disclosure may have only one of the above-described substances, or may have a combination of two or more.

As described above, the element of the present disclosure may have a very thin thickness. Accordingly, a thickness of the semiconductor layer constituting the element of the present disclosure may also be appropriately adjusted. In one embodiment, the thickness of the semiconductor layer may be in a range of 100 nm to 1,000 nm. In another embodiment, the thickness of the semiconductor layer may be 150 nm or more, 200 nm or more, 250 nm or more, or 260 nm or more, and may be 900 nm or less, 800 nm or less, 700 nm or less, 600 nm or less, 500 nm or less, 400 nm or less, or 300 nm or less.

Further, in the element of the present disclosure, as a material constituting the semiconductor layer, a material which easily absorbs light of a specific wavelength and has difficulty in absorbing light of a different wavelength may be used. That is, in one embodiment, the semiconductor layer may include a semiconductor material. Further, the semiconductor material may be a material which easily absorbs light of a specific wavelength and has difficulty in absorbing light of a different wavelength. Specifically, the semiconductor material may be a material having low absorbance in a mid-infrared region and high absorbance in a near-infrared and visible region. More specifically, the semiconductor material may be a material having low absorbance in the mid-infrared region and high absorbance in the visible light region.

In one embodiment, the semiconductor material may be a semiconductor material having an average extinction coefficient less than 0.01 for light having a wavelength in a range of 1,000 nm to 14,000 nm and an average extinction coefficient greater than or equal to 0.01 for light having a wavelength in a range of 380 nm to 700 nm. Here, a case in which the average extinction coefficient for the light having the wavelength in the range of 1,000 nm to 14,000 nm is less than 0.01 includes a case in which the average extinction coefficient in the wavelength range is less than 0.01 even when an extinction coefficient exceeds 0.01 at a certain wavelength.

Since the MXene has a very high light absorption rate in the visible light region, color control is difficult. However, when a semiconductor layer having the above average extinction coefficient is introduced between the MXene and the dielectric layer, a color of the element may be easily controlled regardless of the MXene. The material may include, for example, a silicon-based material or a germanium-based material.

The element of the present disclosure includes a dielectric present on the semiconductor layer. The dielectric layer is a layer including a dielectric material. The dielectric material refers to, as it is known, a material which generates electric polarization but does not generate a direct current when an electrostatic field is applied thereto.

In the present disclosure, a material having a specific refractive index may be used as the dielectric material. Specifically, the dielectric material may be a material having a low refractive index in a broadband from visible light to mid-infrared light. More specifically, the dielectric material may be a material having a refractive index of 4 or less for light having a wavelength in a range of 380 nm to 14,000 nm. The refractive index of the dielectric material may refer to a refractive index of 4 or less in an entire wavelength range which is defined above. This is because the refractive index of the semiconductor layer for the wavelength light within the above-described range is approximately greater than 4. As such, when the dielectric layer has a lower refractive index than that of the semiconductor layer, since light having visible, near-infrared, and mid-infrared wavelengths may enter the element, efficiency of the element may be improved. Examples of these materials may include zinc sulfide or zinc oxide.

A thickness of the dielectric layer is not particularly limited. In one embodiment, the thickness of the dielectric layer may be in a range of 50 nm to 500 nm. In another embodiment, the thickness of the dielectric layer may be 60 nm or more, 70 nm or more, 80 nm or more, 90 nm or more, 100 nm or more, 110 nm or more, 120 nm or more, 130 nm or more, 140 nm or more, 150 nm or more, 160 nm or more, 170 nm or more, 180 nm or more, 190 nm or more, or 200 nm or more, and may be 400 nm or less, 300 nm or less, 290 nm or less, 280 nm or less, 270 nm or less, 260 nm or less, 250 nm or less, 240 nm or less, 230 nm or less, 220 nm or less, 210 nm or less, or 200 nm or less.

Further, the element of the present disclosure may control a color which recognizes the moving object at a wavelength in the visible light range by adjusting the thickness of the dielectric layer. That is, when the moving object provided with the stealth element is looked at with the naked eye or using a telescope or the like, the color recognized for the moving object may be adjusted by adjusting the thickness of the dielectric layer.

Specifically, when the dielectric layer includes zinc sulfide as a dielectric, the thickness of the dielectric layer may be in the range of 50 nm to 500 nm. In another embodiment, the thickness of the dielectric layer may be 60 nm or more, 70 nm or more, 80 nm or more, 90 nm or more, 100 nm or more, 110 nm or more, 120 nm or more, 130 nm or more, 140 nm or more, 150 nm or more, 160 nm or more, 170 nm or more, 180 nm or more, 190 nm or more, or 200 nm or more, and may be 400 nm or less, 300 nm or less, 290 nm or less, 280 nm or less, 270 nm or less, 260 nm or less, 250 nm or less, 240 nm or less, 230 nm or less, 220 nm or less, 210 nm or less, or 200 nm or less. In this case, a color which may be realized by the element may be in the visible light range.

The stealth element of the present disclosure may have a smaller thickness than the conventional element, and may exhibit desired concealment performance. That is, the element of the present disclosure may achieve all desired effects without using a separate layer other than the above-mentioned layers. Accordingly, in one embodiment, the element of the present disclosure may be consisted of the MXene layer, the semiconductor layer present on the MXene layer, and the dielectric layer present on the semiconductor layer. That is, in this embodiment, the element of the present disclosure may be a stacked structure composed of only the three layers mentioned above.

In another example, the visible and infrared stealth element may include other known components which may be applied to exhibit an original function thereof in addition to the above-mentioned components.

Hereinafter, the visible and infrared stealth element of the present disclosure will be described by way of example. However, the following examples are not intended to limit the scope of the present disclosure.

An element in which a MXene layer composed of a MXene (Ti₃C₂Tₓ) and having a thickness of 1,000 nm, a semiconductor layer composed of germanium and having a thickness of 260 nm, and a dielectric layer composed of zinc sulfide and having a thickness of 200 nm are sequentially stacked was prepared.

1. Thermal Radiation Energy

The thermal imaging camera detects thermal radiation energy. The thermal radiation energy of the element is determined by Planck's law of the following Equation 1.

$${S}_{T} = {\int }_{D} ε ( λ ) τ ( λ ) I ( λ , T ) d λ = {\int }_{D} ε ( λ ) τ ( λ ) \frac{2 {hc}^{2}}{{λ}^{5}} \frac{d λ}{exp ( hc / λ kT - 1 )} \qquad [ Equation 1 ]$$

In Equation 1, S_{T} is the thermal radiation energy of the element, an integration range D is a measurement wavelength range of the thermal imaging camera, I is spectral radiation energy of the element, ε is the emissivity of the element, τ is the atmospheric transmittance, h is the Planck's constant, c is the speed of light, k is the Boltzmann constant, and T is a surface temperature of the element.

Through Equation 1, it can be seen that the thermal radiation energy of the moving object may be reduced by lowering the surface temperature or the emissivity of the element. Further, when the thermal radiation energy is increased at a wavelength in a range of 5,000 nm to 8,000 nm, which is a wavelength outside a measurement range of the thermal imaging camera, thermal stability of the element may be secured through a radiative cooling effect.

As can be seen from Equation 1, the thermal radiation energy is higher as the emissivity is higher, and the emissivity is a function of the measurement wavelength of a detection device. That is, when a configuration of the element is appropriately designed so that the element has low emissivity in a wavelength range of 3,000 nm to 5,000 nm and a wavelength range of 8,000 nm to 14,000 nm, which are detection ranges of the thermal imaging camera, and has high emissivity in a wavelength range of 5,000 nm to 8,000 nm, which is outside the detection ranges, a stealth function for the thermal imaging camera may be exhibited.

According to Kirchhoff's law, the emissivity of the element in a thermal equilibrium state is given by the following Equation 2.

ε=1−R−T [Equation 2]

In Equation 2, c is the emissivity of the element, R is the reflectance of the element, and T is the transmittance of the element.

A MXene has high electrical conductivity, and thus has high reflectance. When a thin film composed of the semiconductor layer and the dielectric layer is applied on the MXene, the light reflectance of the element may be controlled, and when the light reflectance is adjusted as in Equation 2, the emissivity of the element may also be adjusted.

In Equation 2, both the reflectance of the element and the transmittance of the element are functions of a wavelength (k) of measurement equipment. The emissivity of the element of the embodiment may be theoretically calculated, and to this end, a transfer matrix method may be used.

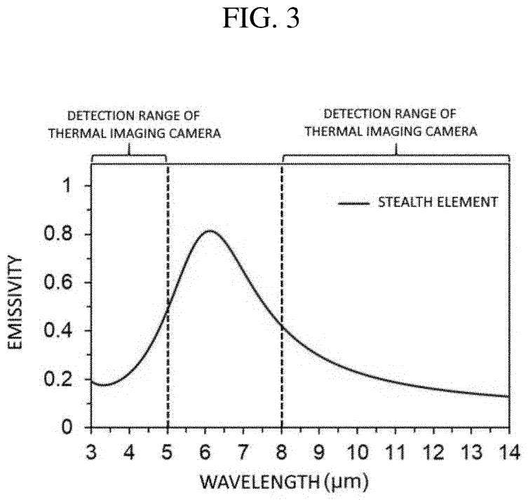

Theoretical thermal emissivity according to the wavelength (3,000 nm to 14,000 nm) of the stealth element acquired through the transfer matrix method was shown in FIG. 3. When the transfer matrix method is used, the permittivity of the MXene was used by interpolation of the experimentally measured permittivity value with a Drude model. A literature value was used for the permittivity of germanium and zinc sulfide. Accordingly, the reflectance and transmittance of the stealth element were calculated. The calculated reflectance and transmittance were substituted into Equation 2 to calculate the emissivity.

According to FIG. 3, it can be seen that the stealth element of the present disclosure shows an emissivity of 0.3 or less for light having wavelengths in the mid-wavelength infrared region and long-wavelength infrared region, which are detection regions of a thermal imaging camera sensor, and shows an emissivity of 0.8 or more for light having a wavelength outside the detection regions of the thermal imaging camera sensor. That is, it can be seen from FIG. 3 that the element of the present disclosure may secure thermal stability while having the excellent concealment performance with respect to the thermal imaging camera.

2. Material Characteristics of MXene

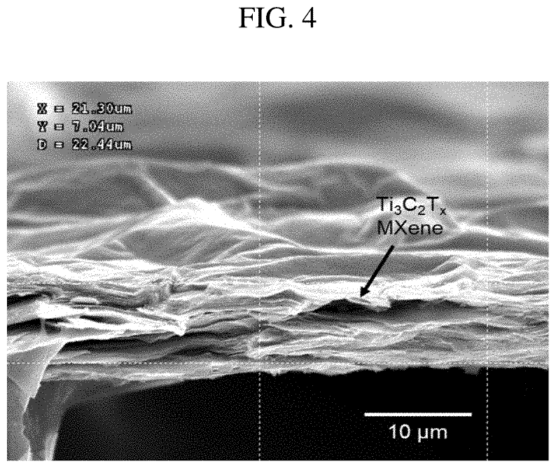

FIG. 4 is a field scanning electron micrograph of the MXene material applied to the element. As confirmed in FIG. 4, since the MXene has a structure in which flakes are stacked, it can be seen that air (layer) is present between the layers. This air (layer) reduces the thermal conductivity of the MXene material. According to Equation 1, the thermal radiation energy of the element is greatly affected by temperature. Accordingly, the MXene has low thermal conductivity due to the air (layer), and accordingly, there may be a thermal insulating action, and thus the thermal radiation energy of the element may be reduced.

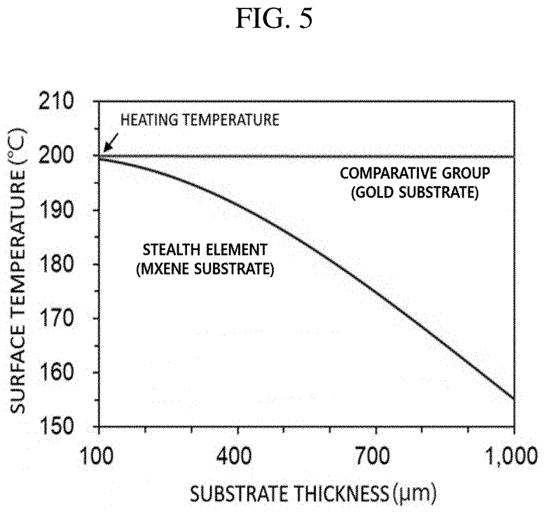

FIG. 5 illustrates the theoretical surface temperature of the stealth element according to the thickness of the MXene. The theoretical surface temperature may be calculated by solving a heat transfer equation for a stacked structure in which the MXene, germanium, and zinc sulfide are sequentially stacked. Boundary conditions for substituting this into the heat transfer equation are as follows.

(1) The MXene layer is a multilayer structure in which flake layers and air layers are repeated.

(2) Heat transfer by convection occurs in the air layer.

(3) Heat transfer by conduction occurs in the flake layer.

(4) Heat movement by radiation is not considered.

A comparative group includes a gold/semiconductor/dielectric thin film element having the same thickness. An ambient temperature was set to 20° C., and a heating temperature was set to 200° C.

Through FIG. 5, in general metals or dielectrics, a difference between the surface temperature and the heating temperature is as small as 1° C. or less at a thickness of 1 mm or less, but in the case of the MXene material, it can be seen that the surface temperature decreases by 20° C. or more even at the thickness of 1 mm or less. Further, in the case of the MXene material, it can be seen that the surface temperature decreases non-linearly as the thickness increases, because the number of air (layers) serving as an insulator increases according to an increase of the thickness of the MXene layer.

3. Short-Wavelength Infrared Camera and Night Vision Goggles

The short-wavelength infrared camera and the night vision goggles use infrared signals reflected by the moving object.

The intensity of the infrared signals reflected by the moving object is given by the following Equation 3:

S_{R}=∫_{D}τ(λ)R(λ)D*(λ)dλ [Equation 3]

In Equation 3, S_{R} is the intensity of the infrared signals reflected by the moving object, D* is quantum efficiency according to the wavelength of an infrared sensor, and τ and R are the same as mentioned above. The short-wavelength infrared camera and the night vision goggles detect by contrasting the intensity of reflected infrared signals from the moving object and the surrounding environment. Accordingly, in order to reduce a detection rate by the equipment, the reflected infrared signals of the element should be set to have a value similar to a reflected signal from a surrounding natural environment such as grass or soil.

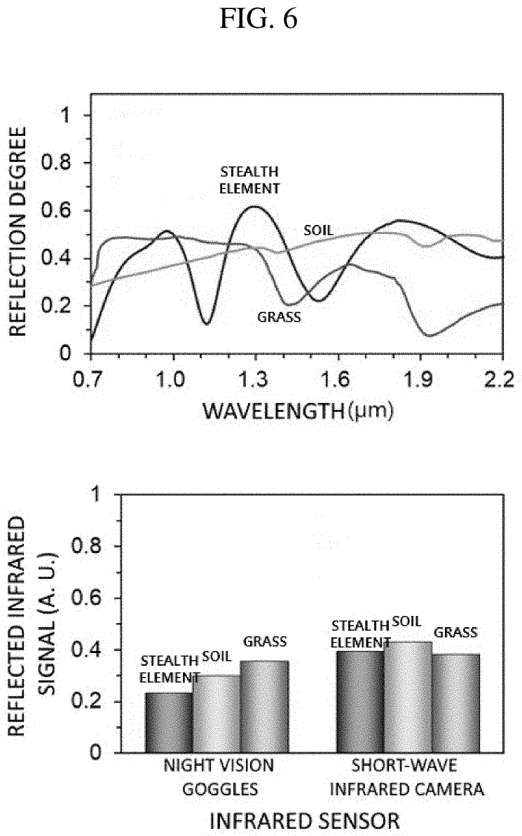

The reflected signals may also be calculated using the above-described transfer matrix method. FIG. 6 illustrates the theoretical light reflectance (top) and intensity of a reflected infrared signal (bottom) according to a wavelength (700 nm to 2,100 nm) of the stealth element of the present disclosure. According to FIG. 6, it can be seen that the difference between the reflected infrared signal of the element according to the embodiment of the present disclosure and the reflected infrared signal of the soil or grass is within 10%.

4. Color of the Element

When a camouflage pattern is made by making the surface color of the moving object similar to the surroundings, the detection rate of the moving object may be lowered when the moving object is detected with the naked eye or using visible light as with a telescope.

A surface color recognized by the naked eye is determined by the reflectance within the visible light wavelength range. The color may be quantified through Commission Internationale de l'Eclairage (CIE) 1931 color coordinates. Trichromatic stimulus values of light corresponding to a CIE standard observer is given by the following Equation 4.

X=∫₀^{∞}R(λ)x̅(λ)dλ, Y=∫₀^{∞}R(λ)y̅(λ)dλ, Z=∫₀^{∞}R(λ)z̅(λ)dλ [Equation 4]

Herein, x̅, y̅, and z̅ are color-corresponding functions for red, green, and blue. For reference, the above is as defined by the CIE and has no relation with the structure of the element. Coordinates of a chromaticity distribution table may be calculated from the trichromatic stimulus values X, Y, and Z of light according to the following Equation 5.

$$x = \frac{X}{X + Y + Z} , \qquad [ Equation 5 ]$$

$$y = \frac{Y}{X + Y + Z}$$

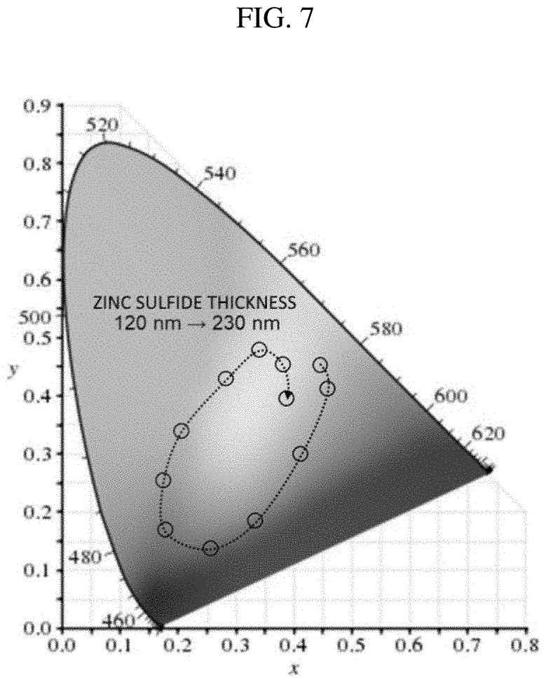

FIG. 7 illustrates CIE color coordinates of the stealth element of the present disclosure. Specifically, the color coordinates of the element are two-dimensionally shown in FIG. 7 using the coordinates of the chromaticity distribution table calculated by Equation 5. A circular mark in the color coordinates in FIG. 7 is a color of the stealth element according to the thickness of the zinc sulfide (thickness of the dielectric layer). The thickness of the zinc sulfide was changed from 120 nm to 230 nm at 10 nm intervals. When the thickness of the zinc sulfide is changed, optical characteristics of the stealth element are also changed, and accordingly, it can be seen that various colors may be realized.

Accordingly, it can be seen that the element of the present disclosure may reduce the detection rate even when detection is performed using not only infrared light but also through the naked eye or the telescope using visible light, and specifically, this is possible by adjusting the thickness of the dielectric layer of the element.

A visible and infrared stealth element of the present disclosure is low-cost.

The visible and infrared stealth element of the present disclosure has a large area.

The visible and infrared stealth element of the present disclosure can exhibit a concealing function of a moving object in a wide range of wavelengths from visible light to infrared light.

The visible and infrared stealth element of the present disclosure has all the above-described characteristics.

What is claimed is:

1. A visible and infrared stealth element, comprising:
a MXene layer;
a semiconductor layer present on the MXene layer; and
a dielectric layer present on the semiconductor layer.

2. The stealth element of claim 1,
wherein a thickness of the MXene layer is 200 nm or more.

3. The stealth element of claim 1,
wherein the MXene layer includes a MXene represented as the following Chemical Formula 1:
Mₙ₊₁XₙTₓ [Chemical Formula 1]
In Chemical Formula 1,
M is a group IIIB metal, a group IVB metal, a group VB metal, or a group VIB metal,
X is C, N, or a combination thereof,
Tₓ is O, F, —OH, or Cl, and
n is an integer in a range of 1 to 4.

4. The stealth element of claim 1,
wherein the MXene layer includes a MXene represented as the following Chemical Formula 2:
M′₂M″ₙXₙ₊₁Tₓ [Chemical Formula 2]
In Chemical Formula 2,
M′ and M″ are each independently a group IIIB metal, a group IVB metal, a group VB metal, or a group VIB metal,
M′ and M″ are different from each other,
X is C, N, or a combination thereof,
Tₓ is O, F, —OH, or Cl, and
n is an integer of 1 or 2.

5. The stealth element of claim 1,
wherein a thickness of the semiconductor layer is in a range of 100 nm to 1,000 nm.

6. The stealth element of claim 1,
wherein the semiconductor layer includes a semiconductor material, and
wherein the semiconductor material is the semiconductor material having
an average extinction coefficient of less than 0.01 for light having a wavelength in a range of 1,000 nm to 14,000 nm, and
an average extinction coefficient of 0.01 or more for light having a wavelength in a range of 380 nm to 700 nm.

7. The stealth element of claim 6,
wherein the semiconductor material is a silicon-based material or a germanium-based material.

8. The stealth element of claim 1,
wherein the dielectric layer includes a material having a refractive index of 4 or less for light having a wavelength in a range of 380 nm to 14,000 nm.

9. The stealth element of claim 7,
wherein the material having a refractive index of 4 or less for light having a wavelength in a range of 380 nm to 14,000 nm includes zinc sulfide or zinc oxide.

10. The stealth element of claim 9,
wherein the material having a refractive index of 4 or less for light having a wavelength in a range of 380 nm to 14,000 nm includes zinc sulfide, and
wherein a thickness of the dielectric layer is in a range of 50 nm to 500 nm.

11. The stealth element of claim 1,
wherein the visible and infrared stealth element consists of the MXene layer, the semiconductor layer, and the dielectric layer.
